(19) United States
(12) Patent Application Publication
(10) Pub. No.: US 2008/0034374 A1
(43) Pub. Date: Feb. 7, 2008

(54) Name tagging of music files

(75) Inventor: Scott Davis, N. Vancouver (CA)

Correspondence Address: HARRINGTON & SMITH, PC, 4 RESEARCH DRIVE, SHELTON, CT, 06484-6212, US

(73) Assignee: Nokia Corporation

(21) Appl. No.: 11/499,434

(22) Filed: Aug. 4, 2006

(51) Int. Cl. G06F 13/00

(52) U.S. Cl. 719/314

(57) ABSTRACT

A message such as an email or a MMS message is receiving from a sender over a communication link that includes a media file, such as a MP3 music file, a podcast, or the like. After receiving the message, a keyword that is independent of a content of the media file is automatically generated, and is automatically stored in a metadata field of the media file. In an embodiment, the generated keyword is selected from a locally stored contact list so as to identify the sender of the message that included the media file, enabling the user to identify who sent that media file originally. In other embodiments, the keyword is generated and stored as metadata of the media file by the sender himself, before the message bearing the media file is sent. Users may use the “sender” metadata field to sort or otherwise organize media files.

### TECHNICAL FIELD

The teachings detailed herein relate to electronic metadata associated with an entertainment file, such as for example metadata that can be used for indexing or organizing a received music file.

### BACKGROUND

As portable digital music players have grown in popularity and storage capacity, the art has addressed a need to organize these large music libraries in a user-friendly manner. Traditionally, individuals organized their music library by artist and album, and portable digital music players continue that regimen. In the field of personal digital music libraries, and in addition to artist, album and song title, it is also known to electronically associate each music file with a specific genre, date downloaded/uploaded to the current storage device, date last played, and number of times played. These are termed generally as metadata; data fields associated with the particular file in what was traditionally referred to as CD header information. Metadata is sometimes also referred to as keywords or tags. Recent search engines as Podzinger and Blinx automatically generate keywords by converting audio content of the underlying file to text. Consistently, keywords depend on the content of the underlying file to which they are associated, so as to enable users to logically sort and organize their personal media libraries. At least Apple Computer's iTunes® software program enables users to overwrite keywords in at least some of metadata fields, and to organize or search their personal music libraries by the various metadata or by playlists of manually selected music files.

One prior art software product in the field of keywords/tags/metadata is marketed as a “1^{st}-MP3-Tag-Editor”, available over the internet in downloadable software at a website bearing that same name and registered to Maniactools of Ukraine. The 1^{st}-MP3-Tag-Editor purports to enable a user to automatically add tags to music files currently lacking them by accessing a database that emulates audio CD header information, or to automatically generate missing tag information by parsing existing filenames and folder paths. It also appears to enable a user to manually overwrite or fill in tag information by individual song or by selected batches. This software appears to automate, at least for some music files, the otherwise burdensome process of manually adding keywords to at least some metadata fields. This is seen as valuable for music uploaded from an older CD to a locally stored library of a device, since older CDs provide the music in digital form but may lack metadata for sorting and organizing completely.

As personal digital music libraries become more ubiquitous, certain groups of users are no longer satisfied with only organizing music files by artist, album or genre. Many individuals maintain music libraries in the thousands of songs, and the addition of ‘podcasts’, photos, and other electronic media files make continuous manual organization of such libraries cumbersome. As the personal libraries of high-volume users expand in breadth and type of media files, the need to more appropriately organize increases. This is because an expanding library necessarily leads to at least some of the keywords, by which a user organizes or searches his personal library, comes to encompass too many files for the user to quickly find an individual one. What is needed in the art is a different approach to organizing and searching media files that are electronically stored in a personal digital library.

### SUMMARY

The foregoing and other problems are overcome, and other advantages are realized, in accordance with the presently described embodiments of these teachings.

In accordance with an exemplary embodiment of the invention, there is provided a method that includes receiving from a sender over a communication link a media file. After receiving the media file, a keyword that is independent of a content of the media file is automatically generated. After generating the keyword, the generated keyword is automatically stored in a metadata field of the media file.

In accordance with another exemplary embodiment of the invention, there is provided a method that includes, in response to a user selecting a media file for transmission, automatically generating a keyword that is independent of a content of the media file and adding the keyword to metadata associated with the media file. The media file with the generated keyword is then sent to an intended recipient over a communication link.

In accordance with another exemplary embodiment of the invention, there is provided a program of machine-readable instructions, tangibly embodied on an information bearing medium and executable by a digital data processor, to perform actions directed toward associating a keyword with a media file. The actions include, in response to receiving a media file from a sender over a communication link, automatically generating a keyword that is independent of a content of the media file. After that keyword is generated, it is automatically stored in a metadata field of the media file.

In accordance with another exemplary embodiment of the invention, there is provided a program of machine-readable instructions, tangibly embodied on an information bearing medium and executable by a digital data processor, to perform actions directed toward associating a keyword with a media file. In this program, the actions include, responsive to a user selecting a media file for transmission, automatically generating a keyword that is independent of a content of the media file and adding the keyword to metadata associated with the media file. The media file with the generated keyword as metadata is then sent to an intended recipient over a communication link.

In accordance with another exemplary embodiment of the invention, there is provided an electronic device that includes means for sending or receiving a first media file over a communication network, processing means, and memory means. The memory means is for storing a library of media files, including the first media file. The processing means is coupled to the means for sending, and is for automatically generating a keyword for the first media file that is unrelated to a content of said first media file, and for associating the generated keyword in metadata of the first media file. In certain embodiments, the means for sending may include a modem or a wireless transceiver, the memory means is a computer readable storage medium of any particular type (optical, electronic, magnetic, etc.), and the processor means includes a microprocessor. In some embodiments where the first media file is to be sent over the network, the processor generates the keyword after a user selects the first media file (such as by appending it to an email or MMS message) but before it is sent over the network. In other embodiments, for the case where media file is received over the network, the processor generates the keyword automatically upon a command to store the first media file in the library, and stores that first media file with the generated keyword as metadata.

Further details as to various embodiments and implementations are detailed below.

### BRIEF DESCRIPTION OF THE DRAWINGS

The foregoing and other aspects of these teachings are made more evident in the following Detailed Description, when read in conjunction with the attached Drawing Figures, wherein:

FIG. 1A is a prior art view of a table of metadata for a library of media song files.

FIG. 1B is a conceptualized view of a method according to an embodiment of the invention, where a media file attached to a message is received, a contact list is accessed, and a metadata table is populated with the attachment and an entry from the contact list, which is now metadata of the archived media file.

FIG. 2 is a schematic diagram of a receiving mobile station in which the present invention may be embodied, in communication with a sending mobile station.

### DETAILED DESCRIPTION OF EMBODIMENTS OF THE INVENTION

In general, the teachings herein enable automated metadata that is personal to the user rather than merely reflective of and generic to the content of the underlying media file. Whereas prior art metadata field keywords, that are not manually generated by the individual user of the digital library, are seen to be generic and typically descriptive of the media file contents, the automated metadata fields disclosed herein are personal to the receiver of the file and may differ among different users for the exact same underlying file. As used herein, a media file includes files with musical, video or image content, or any combination of them. A media file may be audio, video, image or a combination of them, and may take any particular digital compression format, now known or yet to be developed, such as for example MP3, AAC, WMA, JPG, AVI, MOV, MP4, JPG, GIF, PNG, PDF and MPG, to name but a few.

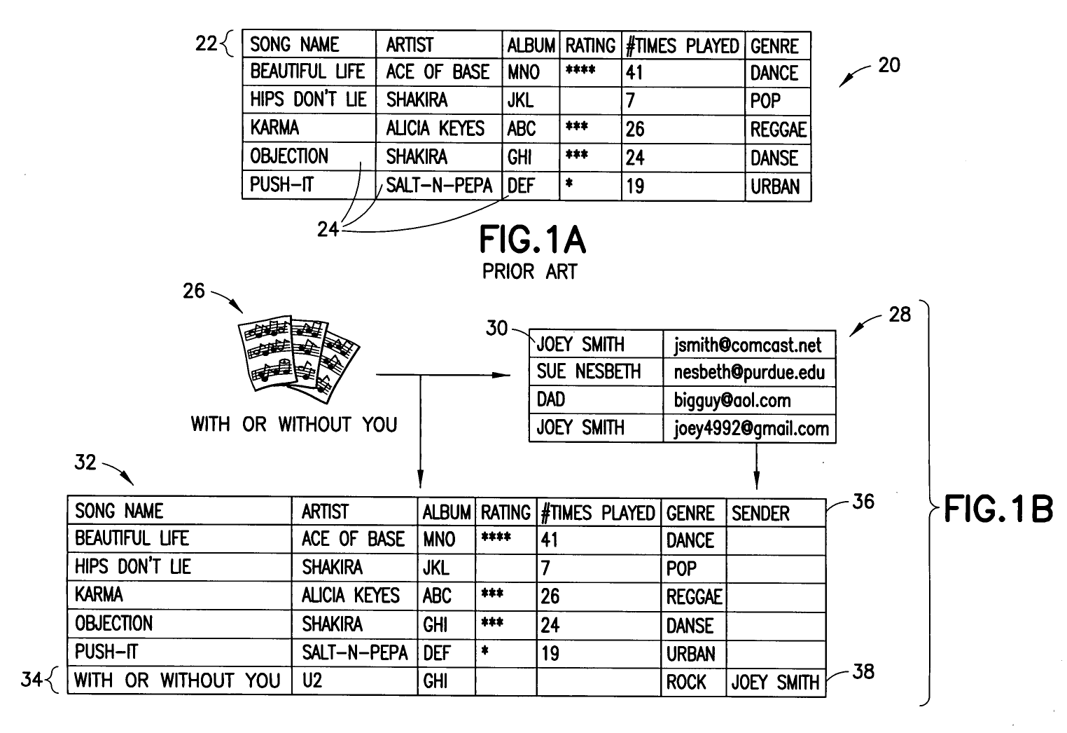

FIG. 1B illustrates conceptually an embodiment of the invention. As background, FIG. 1A is a prior art table 20 of metadata for music files, and includes metadata fields 22 (the columns of the table 20) and keywords 22 for at least some metadata fields. FIG. 1A shows some common metadata fields for five songs, including song name, artist, album, rating, number of times played (a statistical usage field), and genre. All but the rating metadata field are typically generated automatically, though users may manually overwrite automatically generated keywords or add keywords for metadata fields lacking an entry, as noted above. Each row entry of the table 20 represents metadata associated with the underlying media file, and forms a part of that underlying media file distinct from its entertainment content. The table 20 is merely a convenient way of showing the metadata for a library of media files. While only music file metadata is shown in FIG. 1A, it will be appreciated that these teachings extend also to other media file types such as those noted above.

Assume that the table 20 of FIG. 1A, along with the underlying media files, is stored in a device such as a multi-media capable mobile station or laptop/desktop computer. Moving to FIG. 1B, now assume that a sender, Joey Smith, sends a sent media file 26 that is not currently stored locally in the device. The sent media file 26 may be sent as a stand-alone file or in an email, a multi-media message (MMS), or any other particular message type. The sent media file 26 may be a true attachment or within the body of the host message. For example, the media file 26, or its host message, may be sent over a wireless telephony network, via a wireless direct link between portable devices such as Bluetooth or infrared, via a peer-to-peer file swapping arrangement such as BitTorrent, via the Internet, or any other communication link.

At some point, such as automatically upon opening the sent media file 26 or upon manually saving that sent media file 26 in the receiving device, the sent media file 26 is added as a new media file 34 to the local library. Because the sent media file 26 includes the keywords 24 for at least some of the metadata fields from the sender (e.g., title, artist, album, genre, but typically not the user-specific (user-specified) fields such as rating, date downloaded, number of times played, etc.), the updated table 32 at the receiving device will list those received metadata fields and keywords from the sent media file 26 in the row for the new media file 34. The receiving device may perform some filtering prior to adding that file to the local media library, such as checking file type to determine that it is in fact a media file and what type, before operating on the file according to these teachings. For example, only files having an audio component or files of a particular type will have the keyword, generated as detailed below, attached thereto as metadata. The keyword may also be generated in some embodiments by the sender, as when the sender selects a media file for transmission by appending it to or incorporating it within an email or MMS message.

In accordance with these teachings, after the sent media file 26 is received at the device, a keyword 38 is automatically generated that is independent of the content of that sent media file 26. Note that all keywords 24 of the prior art table 20 of FIG. 1A relate to content of the underlying file, and any keywords that might be made to be unrelated to content in the prior art are seen to be manually entered by a user, whether manually appended to individual files or batches of files. This keyword 38 is personal to the manner in which the sent media file 26 was received. Specifically, the generated keyword 38 is an identification of the sender of the sent media file 26. Consider also in FIG. 1B that there is a contact list 28, locally stored at the receiving device. It is known to associate email/instant messaging/MMS addresses (right hand column of the list 28) with a user-defined entry 30 in such a contact list 28, so that the user of the device may readily identify senders and recipients apart from email/IM/MMS addresses that may not always be intuitively clear. The generated keyword 38 is in one embodiment selected as the user-defined entry 30 from the locally stored contact list 28 that is associated in that list 28 with the sender of the sent media file 26, which is present when the sent media file 28 is within a host message and in most cases where it is sent as a stand-alone file. The updated metadata table 32 now reflects an additional metadata field over and above the prior art table 20 of FIG. 1A; which is termed herein a metadata sender field 36. The metadata sender field 36 is populated with the user-defined entry 30 from the contact list 28 automatically for that new media file 34 received (as the sent media file 26) from that same sender. In FIG. 1B, only the added media file 34 was received from a sender; all others were otherwise added to the underlying library since no other media file indicates a sender in the metadata sender field 36. It will be appreciated that the generated keyword 38 is appended as metadata to the new media file 34 stored in the receiver's personal digital library; the updated table 34 merely reflects metadata from various files in the library.

Note that in the contact list, the sender “Joey Smith” is associated with two distinct electronic addresses. As illustrated, both electronic addresses bear the same user-defined entry, so the generated keyword 38 does not distinguish from which electronic address the attachment 26 was received in this instance. When a user of the receiving device searches or otherwise organizes media files by the metadata sender field 36, the criteria may be the user-defined entry (which may span more than one electronic address as shown) or the unique underlying electronic address. Where the contact list 28 bears no user-defined entry 30 for a sender's electronic address, the generated keyword 38 may be the electronic address itself.

For the case where the sender also uses the teachings herein, that sender's metadata table may include a metadata sender field 36. If so, and for the case where the sender sends (e.g., by email or MMS) a sent media file 26 with a metadata sender field completed, the recipient's device may in one embodiment overwrite the received keyword in the metadata sender field. Alternatively, the metadata sender field 36 may include a chain of sender identifications, of which the most recent sender is hierarchically highest in the chain.

For the case where the recipient's electronic library has no entries for which a metadata sender field exists (and consequently the metadata table 32 does not list a metadata sender field 36), that field 36 may simply be added upon storing of the first sent media file 26 received from a sender.

It is contemplated that some prolific senders of media files might prefer to monitor whether their media file attachments, sent to one or more recipients, were well received. Embodiments of this invention therefore enable the sender to access the recipient devices, possibly with the prior electronic permission of the recipient device user, so as to view usage statistics. Specifically, the sender is enabled to access, at least for those media files associated with the metadata sender field associated with that user, metadata usage field(s) such as “number of times played” shown in FIG. 1A. The sender can then assess usage statistics for those media files that he/she sent, and can filter according to those statistics in order to share the more popular choices with others. This enables people to share their music or other media files in new ways, based on the usage statistics of a known circle of friends rather than relying on more generic chart rankings to assess music's popularity. The sender device may be enabled to automatically access, and/or the recipient device may be enabled to automatically report to the original sender, data concerning files that cross a preset or selected threshold of user statistics, such as played more than x times over a y time period, or shared with z number of other persons/devices, etc. Where the sender field is appended to list a chain of senders through which the sent media file 26 has moved, individual users within the chain as well as the current recipient can filter to see who sends them their more favored files, or who originates them, or who already has copies of certain sent media files 26. The sender may further access the more generic metadata fields such as title, artist and album so that he/she may readily associate a particular media file with that usage data. In such an embodiment, the sender device may query the recipient device, and the recipient device may allow full or limited access to some or all of the metadata fields. Such access may be allowed of filtered by the recipient device.

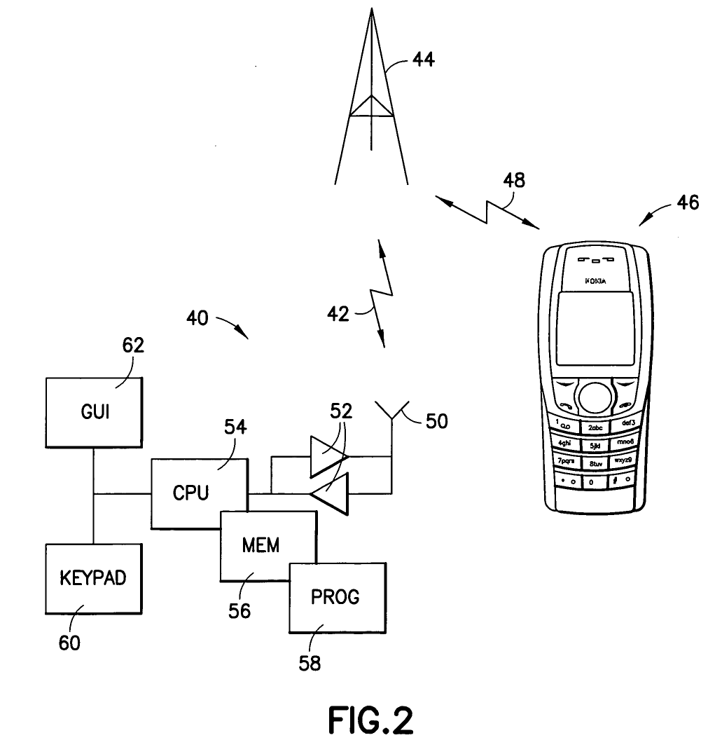

FIG. 2 illustrates a schematic diagram of a receiving mobile station (MS) 40 in which the present invention may be embodied. The present invention may be disposed in any host computing device, whether portable or not, so long as it is enabled to receive a communication from a sending device. As will be detailed below, aspects of the invention may also be embodied in a sending device, portable or not, that is enabled to send a media file 26. In FIG. 2, the receiving MS 40 receives a message on a downlink 42 via a communication network 44, shown there as a wireless network base transceiver station. The message originates with a sending device 46, also depicted as a MS, that transmits the message to the network 44 on an uplink 48. Both links 42, 48 may be bi-directional wireless links as shown. In certain embodiments, the network may be a wired network such as the Internet or an intranet (with or without wireless nodes between the devices 40, 46), a wideband or local area network LAN/WLAN, or in some instances the sending device 46 and the receiving device 40 may communicate directly, without an intervening network 44, for instance via USB or other wired connections or via a Bluetooth or IR link as above.

A MS 40, 46 specifically is a handheld portable device that is capable of wirelessly accessing a communication network, such as a mobile telephony network of base stations that are coupled to a publicly switched telephone network. A cellular telephone, an email appliance, a device that accesses only local networks such as a LAN or intra-net, and a personal digital assistant (PDA) with internet or other two-way communication capability are examples of a MS 40. While not shown, wireless portable devices include a battery as a power source. While portable devices 40, 46 are shown in FIG. 2, the invention may be practiced by a desktop or laptop computer, or other type of computing device, without departing from these teachings.

The component blocks illustrated for the receiving MS 40 in FIG. 2 are functional and the functions described below may or may not be performed by a single physical entity as described with reference to FIG. 2. Sent media files 26 are received at an antenna 50 (one or more), which are passed to a transceiver 52. The MS 40 may additionally have secondary transmitters and receivers for communicating over additional networks, such as a WLAN, WIFI, Bluetooth®, or to receive digital video broadcasts. The sent media file 26 (with or without a host message) may be received over any of these protocols. A processor 54, such as a central processing unit CPU, a digital signal processor, or the like, operates with the transceiver 52 to perform digital sampling, decimation, interpolation, encoding and decoding, modulating and demodulating, encrypting and decrypting, spreading and despreading (for a CDMA compatible MS 32), and additional signal processing functions known in the art.

Computer software programs 58 such as algorithms to modulate, encode and decode, data arrays such as look-up tables, and the like are stored in a main memory storage media 56 which may be an electronic, optical, or magnetic memory storage media as is known in the art for storing computer readable instructions and programs and data. The main memory 56 is typically partitioned into volatile and non-volatile portions, and is commonly dispersed among different storage units, some of which may be removable. The one or more antennas 50 are selectively coupled via a T/R switch or a diplex filter (not shown) to portions of the transceiver 52. Most of the above-described components, and especially the processor 54, are disposed on a main wiring board (not shown), which typically also includes a ground plane to which the antenna(s) 50 is electrically coupled.

A graphical user interface GUI 62, such as graphical display screen, and a user input device 60, complete the relevant portions of the receiving MS 40. The input device is for converting user inputs to electrical or optical signals, such as inputs at an array of user actuated buttons and/or a joystick. Tactile inputs at the graphical user interface 62, and aural inputs at a microphone (not shown), may also operate as the user input device 60.

In accordance with embodiments of the invention, the sent media file 26 (alone or within a host message) is received at the receiving MS 40 and decoded at the transceiver 52. One program 58 opens the email/MMS message itself (if present); another program 58 opens the sent media file 26. Stored in the memory 56 is also a digital media library, including metadata fields and keywords for those fields associated with the specific media files of the library. A contact list 28 may also be stored in the memory 56. The processor 54, in conjunction with software 58, causes the digital media library to be updated 34 with the sent media file 26, and generates a keyword 38 for a metadata sender field 36 that identifies the sender of the sent media file 26. The updated metadata table 32 may be displayed at the GUI 62. Where there is no user-defined entry 30 in the contact list 28, the sender's electronic address in the header attached to the sent media file 26 may be used to fill the metadata sender field 36.

A user of the receiving device 40 may select either an electronic address or a user-defined entry 30 from the contact list 28, or more simply may select a keyword 38 from the metadata table 32, and search for all songs or other media files bearing that sender's identification in the metadata sender field, and thus view the totality of that sender's sent media files 26 (that have not been deleted). In this manner, a user of the receiving device can readily ascertain whether one or another senders typically send media files 26 that interest that user or not.

The memory 56 may also store a program 58 by which a user of the device 40 can filter among the metadata, including by sender identification or by chains of sender identifications. The user can then determine who has (or had) copies of the sent media file 26 now on that user's local library, can query other user's devices for their usage statistics, and by compiling and filtering that data can share music in ways not possible in the prior art because the shared usage statistics are among a known circle of persons. Even where a chain of sender identifications includes one or more persons not known to a particular person further down the chain, the usage statistics can be used to find common ground and make an introduction, as the sender identification is already known and stored with the new media file 34 in the local library. Relatedly, advertisers who have recently experimented with targeting certain demographic groups through such circles of friends can access such usage statistics to determine how extensive a particular media file, provided to an original sender, has been circulated and how well it has been received within that circle of acquaintances.

Where the sent media file 26 is copyrighted and digitally protected, digital protection of that file 26 might enable a certain fixed number of copies to be included in the purchased copyright license. Upon each time the media file is sent, a counter embedded within the media file 26 increments/decrements until the maximum number of copies is reached, at which time further copies to be sent to further recipients are electronically disabled. Alternatively or additionally, each recipient can be offered the opportunity to purchase another copy of a particular media file 26 for sharing (or multiple copies). Where the media file is purchased electronically, a metadata field may indicate the source (e.g., apple.com/itunes; creative.gettyimages.com) that is preserved through the various sendings of the sent media file 26, so that downline recipients can search there for additional media files or obtain another license for one or a limited number of copies.

A user of the sending device 46 may also access the system of the receiving device 40 to view metadata usage fields (and preferably other more generic fields such as title/artist/album) for those media files bearing that sender's identification in the metadata sender field, in order to also ascertain whether his sent media files 26 have been well received by a particular recipient.

In certain embodiments of the invention, the appending of the sender's identification in the metadata of the sent media file 26 may be done in the sending device 46, such as after the message is compiled but immediately prior to being sent on the uplink 48. One minor disadvantage in this embodiment is that the user-defined entries in the contact lists 28 of the sender and receiver may differ, so if the user-defined entry 30 from the sender's contact list 28 is used, the user of the receiving device 40 may not recognize it immediately. Alternatively, the electronic address itself of the sender may be appended to metadata prior to being sent, and at the receiving device 40 the contact list 28 is accessed and the user-defined entry 30 that matches the electronic address is written over the metadata sender field 36 for that added media file 34, but this involves an additional step as compared to that detailed above with respect to FIG. 1B.

Embodiments of this invention may be implemented by computer software 58 executable by a data processor 54 of the device 40, 46, such as by hardware, or by a combination of software and hardware. The memory or memories 56 may be of any type suitable to the local technical environment and may be implemented using any suitable data storage technology, such as semiconductor-based memory devices, magnetic memory devices and systems, optical memory devices and systems, fixed memory and removable memory. The data processor(s) 54 may be of any type suitable to the local technical environment, and may include one or more of general purpose computers, special purpose computers, microprocessors, digital signal processors (DSPs) and processors based on a multi-core processor architecture, as non-limiting examples.

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

Although described in the context of particular embodiments, it will be apparent to those skilled in the art that a number of modifications and various changes to these teachings may occur. Thus, while the invention has been particularly shown and described with respect to one or more embodiments thereof, it will be understood by those skilled in the art that certain modifications or changes may be made therein without departing from the scope and spirit of the invention as set forth above, or from the scope of the ensuing claims.

What is claimed is:

1. A method comprising:
receiving from a sender over a communication link a media file;
after receiving, automatically generating at least one keyword that is independent of a content of the media file; and
after generating, automatically storing the at least one generated keyword in a metadata field of the media file.

2. The method of claim 1, wherein the keyword comprises an identification of the sender, and the metadata field comprises a metadata sender field.

3. The method of claim 2, wherein the identification of the sender comprises a user-defined entry associated with the sender in a contact list, said contact list stored locally in a device that executes the method of claim 2.

4. The method of claim 2, wherein automatically storing comprises:
for the case where the received media file includes the metadata sender field, one of overwriting an entry in the metadata sender field of the received media file with the identification of the sender or appending the identification of the sender to an entry in the metadata sender field; or
for the case where the received media file does not include the metadata sender field, creating the metadata sender field and storing the identification of the sender in the created metadata sender field.

5. The method of claim 2, further comprising, after storing the identification of the sender:
storing playback statistics of the media file in a metadata usage field; and
selectively enabling the sender to access, through a communication link, at least the metadata usage field for those media files that bear the identification of the sender in the metadata sender field.

6. The method of claim 2, further comprising:
enabling a user of the device that executes the method of claim 2 to search, on a local storage medium of the device, for media files by the metadata sender field.

7. The method of claim 1, wherein receiving comprises receiving a message to which the media file is an attachment.

8. A method comprising:
in response to a user selecting a media file for transmission, automatically generating at least one keyword that is independent of a content of the media file and adding the keyword to metadata associated with the media file; and
sending the media file with the at least one generated keyword to an intended recipient over a communication link.

9. The method of claim 8, wherein the keyword comprises an identification of the sender of the electronic message.

10. A program of machine-readable instructions, tangibly embodied on an information bearing medium and executable by a digital data processor, to perform actions directed toward associating a keyword with a media file, the actions comprising:
in response to receiving a media file from a sender over a communication link, automatically generating at least one keyword that is independent of a content of the media file; and
after generating, automatically storing the at least one generated keyword in a metadata field of the media file.

11. The program of claim 10, wherein the at least one keyword comprises an identification of the sender, and the metadata field comprises a metadata sender field.

12. The program of claim 11, wherein the identification of the sender comprises a user-defined entry associated with the sender in a contact list, said contact list stored locally in a device in which the information bearing medium and processor is disposed.

13. The program of claim 11, wherein automatically storing comprises:
for the case where the received media file includes the metadata sender field, one of overwriting an entry in the metadata sender field of the received media file with the identification of the sender or appending the identification of the sender to an entry in the metadata sender field; or
for the case where the received media file does not include the metadata sender field, creating the metadata sender field and storing the identification of the sender in the created metadata sender field.

14. The program of claim 11, the actions further comprising, after storing the identification of the sender:
storing playback statistics of the media file in a metadata usage field; and
selectively enabling the sender to access, through a communication link, at least the metadata usage field for those media files that bear the identification of the sender in the metadata sender field.

15. The program of claim 11, the actions further comprising:
in response to a manual user command, searching for media files by the metadata sender field on a local storage medium of the device in which the information bearing medium and processor is disposed.

16. The program of claim 10, wherein the message comprises one of a multi-media message service and an email to which the media file comprises an attachment.

17. The program of claim 10, wherein the information bearing medium and processor are disposed in a mobile station and the communication link comprises a wireless link.

18. A program of machine-readable instructions, tangibly embodied on an information bearing medium and executable by a digital data processor, to perform actions directed toward associating a keyword with a media file, the actions comprising:
responsive to a user selecting a media file for transmission, automatically generating at least one keyword that is independent of a content of the media file and adding the keyword to metadata associated with the media file; and
sending the media file with the generated keyword as metadata to an intended recipient over a communication link.

19. The program of claim 18, wherein the keyword comprises an identification of the sender of the electronic message.

20. An electronic device comprising:
means for sending or receiving a first media file over a communication network;
memory means for storing a library of media files, including the first media file; and
processor means for automatically generating a keyword for the first media file that is unrelated to a content of said first media file, and for associating the generated keyword in metadata of the first media file.

21. The electronic device of claim 20, wherein
the means for sending comprises one of a modem or a wireless transceiver;
the memory means comprises a computer readable storage medium;
the processor means comprises a microprocessor; and
wherein the processor means operates according to at least one of:
for the case where the first media file is to be sent over the network, the processor generates the keyword after a user selects the media file for transmission and sends the first media file with the generated keyword over the network, or
for the case where the first media file is received over the network, the processor generates the keyword automatically upon a command to store the first media file in the library, and stores said first media file with the generated keyword as metadata.

22. The electronic device of claim 21, wherein the memory is for further storing a user-defined contact list and the keyword is generated from the contact list and identifies a sender of the one message.

23. The electronic device of claim 21, wherein the device comprises a mobile station.
